(19) United States
(12) Patent Application Publication
(10) Pub. No.: US 2026/0220139 A1
(43) Pub. Date: Jul. 30, 2026

(54) METHODS AND SYSTEMS FOR INCREMENTAL AGGREGATES USING LSM-STYLE DATASTRUCTURES

(71) Applicant: HUAWEI TECHNOLOGIES CO., LTD., Shenzhen (CN)

(72) Inventor: Robin GROSMAN, Markham (CA)

(73) Assignee: HUAWEI TECHNOLOGIES CO., LTD., Shenzhen (CN)

(21) Appl. No.: 19/041,316

(22) Filed: Jan. 30, 2025

(51) Int. Cl. G06F 16/2455; G06F 16/242

(52) U.S. Cl. CPC G06F 16/24556; G06F 16/244

(57) ABSTRACT

A method for incrementally maintaining aggregates in a data structure, the method including selecting a chunk of data; and determining whether an aggregate exists for the selected chunk of data. When the aggregate exists, determining that a number of deleted rows for the chunk of data exceeds zero; and performing a remove function to remove any deleted rows from the aggregate. When the aggregate does not exist, performing a reduce function to create the aggregate.

### FIELD OF THE DISCLOSURE

The present disclosure relates to database or big data systems, and in particular relates to aggregates used for database or big data systems having immutable data structures.

### BACKGROUND

The background description includes information that may be useful in understanding the present inventive subject matter. It is not an admission that any of the information provided herein is prior art or applicant admitted prior art, or relevant to the presently claimed inventive subject matter, or that any publication specifically or implicitly referenced is prior art or applicant admitted prior art.

Modern databases may use a log-structured merge (LSM) storage architecture to support high write throughput. LSM architectures aggregate writes into a table, generally referred to as a MemTable, which can be changed and is thus mutable. Such MemTable is stored in memory, and is regularly flushed to disk, creating an immutable file called a Stored String Table or SSTable. An aggregate is a collection of SSTables that are merged into a single SSTable.

Aggregates today are maintained in various ways. In a first option, data is periodically re-calculated in a batch. For example, this may be hourly, daily, every minute, among other options. Readers, however, may encounter stale data, which may not be the same as the currently committed data in the original table.

In a second option, updates may be executed every time a query is executed, and the query may be cached until updates are run. This requires a full recompute of the aggregate. If queries are frequent and updates are frequent, this can result in significant extra computation, which may for example increase computation by ten or one hundred times, and may take significant re-computation resources.

In a third option, data may be updated in the cache every time a new update is made to the table. This incremental maintenance may be expensive, as it requires at least two times computation performed synchronously when the data is updated, since new data needs to be written to cache as well for every update. If there are multiple aggregates to maintain, the cost increases per aggregate.

All these options have significant overhead for constantly changing tables. Further, a user of such system may need to guess at the access patterns, which may change over time, to select a method of updating. Therefore, there is a need for a method that is good for incremental aggregate caching, regardless of the access pattern.

### SUMMARY

According to at least a first aspect of the present disclosure, there is provided a method for incrementally maintaining aggregates in a data structure, the method comprising: selecting a chunk of data; determining whether an aggregate exists for the selected chunk of data; when the aggregate exists: determining that a number of deleted rows for the chunk of data exceeds zero; and performing a remove function to remove any deleted rows from the aggregate; and when the aggregate does not exist performing a reduce function to create the aggregate.

In a first implementation of the first aspect, the method further comprises: when the aggregate exists: determining that a number of deleted rows in the aggregate exceeds a threshold; and performing the reduce function to create a new aggregate.

In a second implementation of the first aspect, the data structure is an immutable or an append data structure having a deleted rows indicator.

In a third implementation of the first aspect, wherein the method is performed asynchronously.

In a fourth implementation of the first aspect, the aggregate is one of: a sum; a minimum; a maximum; an average; a number of records; and a product of data within the data structure.

In a fifth implementation of the first aspect, the reduce and remove functions are tailored to a type of aggregate.

In a sixth implementation of the first aspect, for a sum aggregate, the reduce function adds a row value to the aggregate and the remove function subtracts a row value from the aggregate.

In a seventh implementation of the first aspect, the data structure is a log-structured merge (LSM) storage architecture.

In an eighth implementation of the first aspect, the method further comprises creating aggregate tables merging aggregates together.

In a ninth implementation of the first aspect, the method further comprises updating a full aggregate with results from the reduce or remove function.

In a second aspect, a computing device for incrementally maintaining aggregates in a data structure is provided. The computing device comprises a memory; and a processor, wherein the computing device is configured to: select a chunk of data; determine whether an aggregate exists for the selected chunk of data; when the aggregate exists: determine that a number of deleted rows for the chunk of data exceeds zero; and perform a remove function to remove any deleted rows from the aggregate; and when the aggregate does not exist: perform a reduce function to create the aggregate.

In a first implementation of the second aspect, the computing device is further configured to, when the aggregate exists: determine that a number of deleted rows in the aggregate exceeds a threshold; and perform the reduce function to create a new aggregate.

In a second implementation of the second aspect, the data structure is an immutable or an append data structure having a deleted rows indicator.

In a third implementation of the second aspect, the aggregate is one of: a sum; a minimum; a maximum; an average; a number of records; and a product of data within the data structure.

In a fourth implementation of the second aspect, the reduce and remove functions are tailored to a type of aggregate.

In a fifth implementation of the second aspect, for a sum aggregate, the reduce function adds a row value to the aggregate and the remove function subtracts a row value from the aggregate.

In a sixth implementation of the second aspect, the data structure is a log-structured merge (LSM) storage architecture.

In a seventh implementation of the second aspect, the computing device is further configured to create aggregate tables merging aggregates together.

In an eighth implementation of the second aspect, the computing device is further configured to update a full aggregate with results from the reduce or remove function.

In a third aspect there is provided a computer readable medium for storing instruction code, which, when executed by a computing device configured for incrementally maintaining aggregates in a data structure, cause the computing device to: select a chunk of data; determine whether an aggregate exists for the selected chunk of data; when the aggregate exists: determine that a number of deleted rows for the chunk of data exceeds zero; and perform a remove function to remove any deleted rows from the aggregate; and when the aggregate does not exist: perform a reduce function to create the aggregate.

### BRIEF DESCRIPTION OF THE DRAWINGS

The present disclosure will be better understood having regard to the drawings in which:

FIG. 1 is a block diagram showing compute unit column-store tables which may be used for some embodiments of the present disclosure.

FIG. 2 is a block diagram showing a metadata table for each column of the embodiment of FIG. 1.

FIG. 3 is a process diagram used to create aggregates on chunks that do not have aggregates.

FIG. 4 is a process diagram showing a reader process to update or create aggregates.

FIG. 5A is a block diagram showing an LSM with one run per level.

FIG. 5B is a block diagram showing a delete mask and aggregate table for the LSM of FIG. 5A.

FIG. 6 is a block diagram showing a data structure with a plurality of chunks, a delete mask and an aggregate table for the chunks.

FIG. 7 is a block diagram showing various levels of aggregates.

FIG. 8 is a block diagram showing an example simplified computing device capable of being used with the embodiments of the present disclosure.

### DETAILED DESCRIPTION OF THE DRAWINGS

In one embodiment, the present disclosure is directed to ways to incrementally maintain aggregates by a background process. Very recent updates will still be synchronously processed by the reader, but these should be very small. A background thread finds recently added data and creates aggregates on “chunks” of data. In various embodiments, these chunks can be Compute Unit (CU) files, parquet row groups, sorted run in an LSM tree, or other structure.

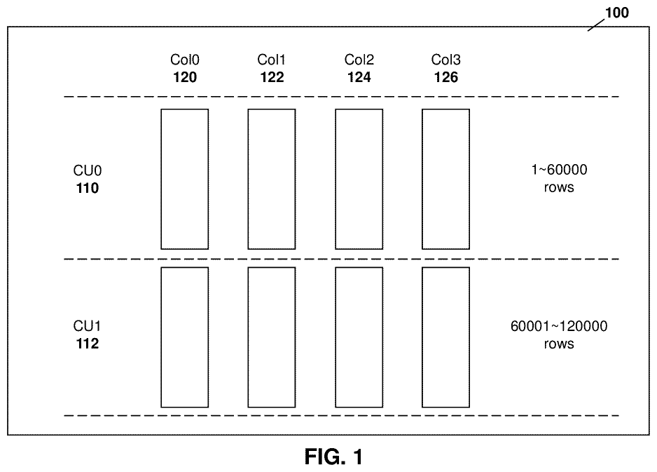

For example, reference is made to FIG. 1, which shows one example of a structure to which the present embodiments can be applied.

In the example of FIG. 1, a column-store table 100 is shown.

Column-store table 100 includes a plurality of rows, which are grouped into compute units 110 and 112 in the example of FIG. 1. For example, each compute unit may hold 60,000 rows in some cases. Thus, in FIG. 1, compute unit 110 holds rows 1 to 60,000, and compute unit 122 holds rows 60,001-120,000. However, this number of rows in a compute unit is merely provided for illustration, and in practice, more or fewer rows may form part of a compute unit. Further, while the example of FIG. 1 only shows two compute units, in other cases more or fewer compute units may exist.

Data in the column-store table 100 may further be stored in a plurality of columns, labeled as columns 120, 122, 124 and 126 in the example of FIG. 1. However, more or fewer columns could exist within a column store table 100 in practice.

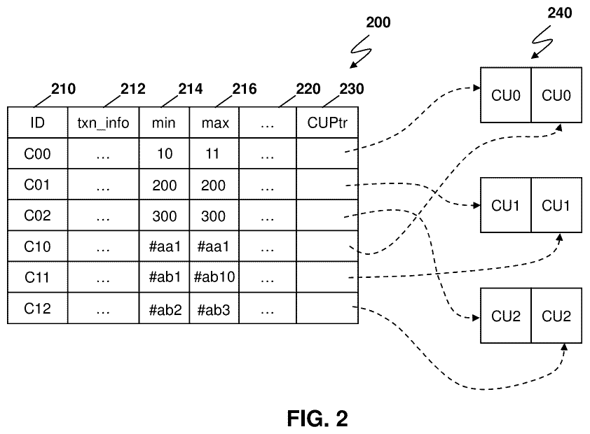

Each compute unit 110 and 112 may have a metadata entry within table 100 for each column 120, 122, 124 and 126. There may further be an entry (not shown) within table 100 providing a bitmask of which rows have been deleted. Reference is now made to FIG. 2, which shows an example of a metadata table 200.

For example, metadata table 200 includes identifier information 210, transaction information (txn_info) 212, minimum 214, maximum 216, as well as other information 220.

Further, each row in the metadata table 200 may include a pointer 230 to a compute unit 240.

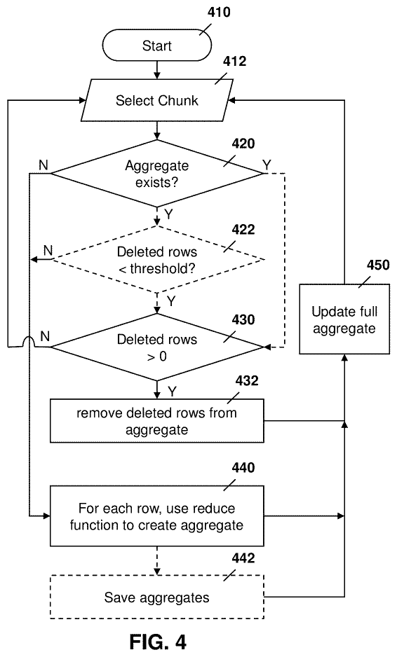

In other cases, an LSM column store table for analytics may be used as a data structure. One example of such table is for example described in Jiang et al., “Alibaba Hologres: A Cloud-Native Service for Hybrid Serving/Analytical Processing”, Proceedings of the VLDB Endowment: Vol. 13, No. 12, 2020, the contents of which are incorporated herein by reference. In particular, the column table of FIG. 4(b) of this reference includes a column LSM tree and a delete map.

However, as indicated above, typically aggregates may be maintained periodically or re-run on a query. This results in either stale data or the need for re-computation. In other cases, aggregates may be updated in cache every time a new update is made to a table. This incremental maintenance can be computationally expensive and may slow down updates to the original table, since the new data needs to be written to both the table and to cache.

Therefore, in accordance with embodiments of the present disclosure, systems and methods are provided to incrementally maintain aggregates without re-computing the whole aggregate, or incurring synchronous processing overhead with every insert, update or delete.

Specifically, methods and systems are provided to incrementally maintain aggregates by a background process.

Very recent updates may still be synchronously processed by the reader, but generally these should be very small.

A background thread may find recently added data and may create aggregates on the “chunks” of data. Such “chunks” can be CU files, parquet row groups, sorted runs in an LSM tree, or other structures. In general, the methods and systems herein may be used for any database or a big data systems which have immutable or append data structures. This is typical in column store databases and analytics systems using, for example, LSM data structures. Typically, when updates are done, the row is not updated in place. Instead, a new row is inserted in a new location in the table and the old row is marked to be deleted.

The methods and systems herein may be implemented using two functions for each aggregate.

A first function is referred to herein as a reduce function. The reduce function may update an aggregate with a new additional value. For example, this may be written as: New_agg=reduce (aggregate, value).

A second function is referred to herein as a remove function. The remove function may update the aggregate by removing a value. For example, this may be written as: New_agg=remove (aggregate, value).

Such functions may be implemented by background processes used to create or refresh aggregates, which may be run periodically.

For example, reference is made to Table 1, which shows a process for creating or refreshing aggregates.

TABLE 1
Create or refresh aggregates

```
For each “chunk” in table:
  If chunk.aggregate not exists or chunk.num_deleted > threshold:
    For each row in “chunk”:
      aggregate = reduce(aggregate, row)
    chunk.Save_aggregate(aggregate)
```

In Table 1, a first step may be to check whether an aggregate for a particular chunk exists. Optionally, the check may include a check on the chunk to see how much of the chunk has been deleted. For example, if a chunk has been 90% deleted, then it may not be worth updating the aggregate for the chunk. 90% is provided as an example threshold in this case, and other thresholds could equally be used.

Thus, from Table 1, if the chunk aggregate does not exist (and in some cases if the deleted rows in the chunk are less than a threshold), then the process may use the reduce function for each row in the chunk. As such, the aggregate for the chunk is updated with the value for each row.

Finally, once the aggregate for each row has been updated using the reduce function, the aggregate can be saved.

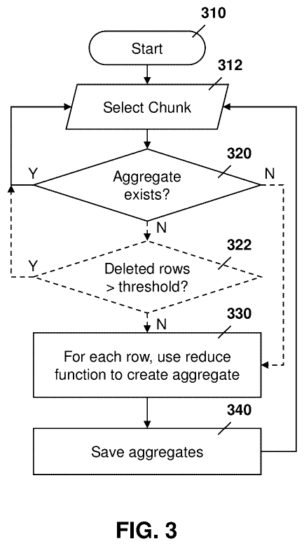

The above is summarized in the example of FIG. 3. In particular, the process of FIG. 3 starts at block 310 and proceeds to block 312 in which a chunk may be selected.

The process then proceeds to block 320 in which a check is made to determine whether the chunk selected at block 312 has an aggregate which exists. If yes, the process may proceed back to block 312 to select a new chunk. As will be appreciated by those in the art, this loop can be optimized, for example if there is an index or other mechanism for finding new chunks which do not have aggregates, and would therefore not need to loop over every chunk in some cases.

From block 320, if the aggregate does not exist, in an optional case the process may proceed to block 322 in which a check is made to determine whether the deleted rows in the chunk exceed a threshold. However, the check at block 322 is optional and, in some cases, if the aggregate does not exist, the process may proceed directly to block 330.

From a block 322, if the number of deleted rows in the chunk exceed a threshold, the process may proceed back to block 312 to select a new chunk in some cases. Conversely, if the check at block 322 finds that the number of deleted rows does not exceed the threshold, then the process may proceed from a block 322 to block 330.

At block 330, for each row in the chunk, a reduce function may be used to create an aggregate for such row. The process then proceeds to block 340 in which the aggregates are saved.

Assuming that the process is a continuous background process or that certain chunks have not yet been processed, from block 340 the process may proceed back to block 312 in which a new chunk may be selected. In other cases, after block 340 the process may end.

A second process is shown with regard to Table 2. The process of Table 2 may be run when a reader is used, for example during a user query process.

TABLE 2
Reader/User Query

```
full_aggregate = 0
For each “chunk” in table:
  If chunk.aggregate exists and chunk.num_deleted < threshold:
    aggregate = chunk.aggregate
    If chunk.num_deleted > 0:
      Deleted_row= get data for deleted row
          aggregate = remove (delete_row, aggregate)
  Else
        For each row in “chunk”:
      aggregate = reduce(aggregate, row)
    //optionally save “aggregate” for this chunk
  full_aggregate = reduce(full_aggregate, aggregate)
  return full_aggregate
```

As seen in the example of Table 2, during a read or user query, a check is made to determine whether the chunk has an aggregate. Optionally, the check may determine whether the number of deleted rows in the chunk is lower than a threshold. As with the example of Table 1, if the number of deleted rows exceeds the threshold, then it may not be worth it to update the aggregate.

If the chunk exists, and if optionally the number of deleted rows in the chunk is lower than the threshold, then a check may be made to determine whether the aggregate for the chunk needs to be updated. In particular, a check may be made to determine whether the number of deleted rows is greater than 0 in the chunk. If yes, the aggregate may be updated by performing the removing function as described above.

Conversely, if the chunk aggregate does not exist (and in some cases if the deleted rows in the chunk are greater than a threshold), then the process may use the reduce function for each row in the chunk. As such, the aggregate for the chunk is created and/or updated with the value for each row.

In some cases, the full aggregate for the chunk may then be saved and may then be returned.

An example of the embodiment of Table 2 is provided with regard to FIG. 4. Specifically, the process of FIG. 4 starts at block 410 and proceeds to block 412 in which a chunk may be selected. The process then proceeds to block 420 in which a check is made of whether the aggregate for the chunk selected at block 412 exists.

From block 420, if the aggregate for the chunk exists, an optional check may be made at block 422 to determine whether the deleted rows in the selected chunk are lower than a threshold.

From block 422, if the deleted rows are less than the threshold, or from block 420 if the optional check for deleted rows is not performed and the aggregate for the chunk exists, the process may proceed to block 430 in which a check is made to determine whether the chunk has one or more deleted rows.

If the number of deleted rows is not one or more, the process may then proceed back to block 412 in which the process may select the next chunk in some cases. In some cases, the selection of chunks for which to perform the process of FIG. 4 may be optimized. Thus, in some examples, an algorithm may be used to select the specific chunk at block 412, or to end the process if chunks have been processed.

Conversely, from block 430, if the number of deleted rows is one or more, the process may proceed to block 432 in which the deleted rows may be removed from the aggregate using the remove function. As described below, this removal may be based on the type of aggregate being calculated.

From block 432, the process may proceed to block 450 in which the full aggregate may optionally be updated. From block 450, the process may then proceed back to block 412 to select the next chunk according to the chunk selection algorithm.

From block 420, if the aggregate does not exist, or optionally from block 422 if the number of deleted rows exceeds a threshold, the process may proceed to block 440. At block 440, for each row, the reduce function may be used to create the aggregate. As described below, this reduce function maybe based on the type of aggregate being calculated.

From block 440, the process may optionally proceed to block 442 in which the aggregate is saved. The process may further proceed from block 440 or from block 442 to block 450 in which the full aggregate is updated. Again, from block 450, the process may precede back to block 412 in which the next chunk is selected according to the chunk selection algorithm.

Therefore, according to Table 2 and FIG. 4, during a user query or reader action, the aggregate for chunks which have had rows deleted may be updated and aggregates for chunks that do not currently have an aggregate may be created.

The reduce and remove functions may be based on the type of aggregate being kept. For example, if the data storage is storing sales for an electronic storefront, the aggregate may represent a sum of sales for a particular user. Thus, the reduce and remove functions could be sum operations.

In this case, the majority of the sales data may be the same between calculations, and the aggregate may therefore be re-computed, using the process of Tables 1 and 2 and FIGS. 3 and 4, on the changes made in the data storage to update the sum of sales.

However, in other cases, the reduce and remove functions could implement any calculation, such as minimum, maximum, average, number of records, product, among others. The present disclosure is therefore not limited to the type of aggregate being kept.

Further, the process of Tables 1 and 2 and FIGS. 3 and 4 may be performed asynchronously in the background, thereby avoiding slowing down write operations.

### LSM-Style Data Structures

The process of Tables 1 and 2 and FIGS. 3 and 4 can be performed on a variety of data structures that keep immutable records with deletion markers. In one case, the embodiments of the present disclosure can be implemented on an LSM-Style Data structure. For example, LSM-style trees can be full LSM on a primary key or use an LSM-tyle compaction but order (and compact) on some cluster key instead of actual primary key in a series of levels which increase in size.

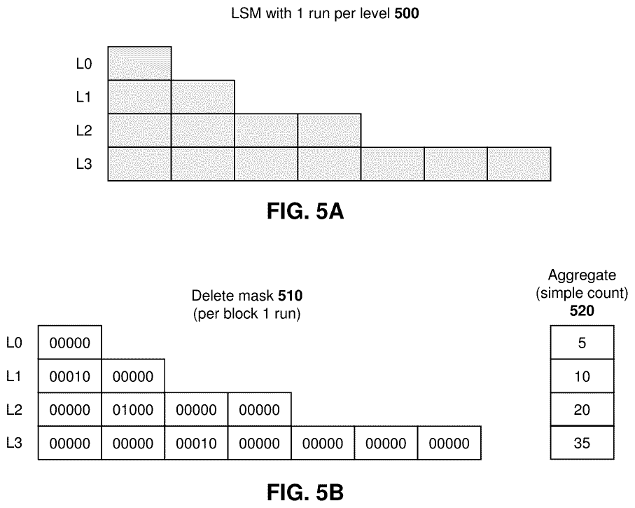

For example, reference is now made to FIG. 5A which shows a simplified LSM 500 with one run per level. The example of FIG. 5A shows level 0 to level 3. However, in practice more or fewer layers could exist in the LSM and the use of four levels is merely provided for illustration.

FIG. 5B illustrates a delete mask 510 per block for one run. Further, FIG. 5B provides an aggregate table 520 which illustrates a simple count.

Specifically, for illustration purposes, in the example of FIGS. 5A and 5B, a simplified aggregate may be provided in which the reduce function is the addition of “1” and the remove function is the subtraction of “1”. This is however only provided for illustration and in practice, the reduce and remove functions can use the actual data values. The use of the addition and subtraction of “1” was therefore provided for clarity only.

Further, in FIGS. 5A and 5B, the number of rows per run in practice would be orders of magnitude higher than that illustrated. The small number of rows in the example of FIGS. 5A and 5B was used to show details of what is being done.

In FIG. 5B, the aggregate table 520 includes the number of chunks within a level. Thus, for level 0, there are 5 chunks within the level. For level 1 there are 10 chunks. For level 2 there are 20 chunks and for Level 3 there are 35 chunks.

The deletion mask 510 may provide “0” if the row has been unchanged and may provide a “1” if a row has been deleted. Specifically, as the rows are immutable in level 1 and lower, rather than amending the row, the row is deleted, and a new row may be placed elsewhere in the LSM table.

The updating of aggregates comprises the use of a background asynchronous compaction process that is part of LSM processing. This has two advantages. A first is that longer and longer runs get created, which means that the aggregate scan can be O(log(N)) for processing, rather than O(N).

A second advantage is that data is already being read or written every time a new level is created so the overhead to create aggregates is decreased.

Thus, using the example of Table 1 and Table 2, and FIGS. 3 and 4, for each run in each level, the aggregate value may be used in which any deleted rows in the run may be removed and the result may be summed. This is shown in equation 1 below using the delete mask 510 of FIG. 5B.

$$L 0 + L 1 + L 2 + L 3 = 5 + ( 10 + ( remove L 1 R 4 ) ) + ( remove L 2 R 7 ) ) + ( 35 + ( remove L 3 R 14 ) ) = 67$$

Thus, as seen from equation 1, the aggregate is the sum of the remaining rows and the deleted rows are removed from the aggregate.

### Columns Store

In a further embodiment, the methods and systems of the present disclosure can be used with other data structures. For example, the algorithms described above with regard to Tables 1 and 2 and FIGS. 3 and 4 could be applied for normal column-store data structures that maintain delete bitmaps for immutable objects. This may include lakehouse snapshots, as well as columnar analytics structures, among other options.

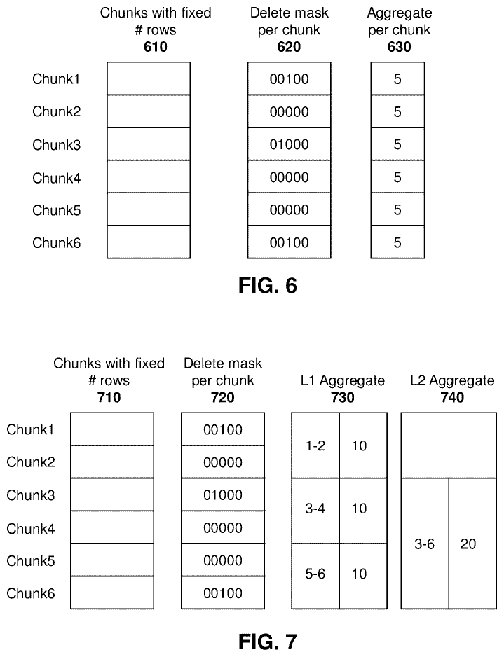

For example, reference is now made to FIG. 6, which shows a plurality of chunks 610 with a fixed number of rows. A delete mask 620 for chunks 610 may be provided. In the example of FIG. 6, a bitmap for the delete mask is shown, where “1” represents a row that has been deleted. However, other structures for delete mask 620 are also possible.

An aggregate table 630 stores aggregates per chunk.

In the example of FIG. 6, initially an aggregate is created on each chunk. Over time, the aggregates can be merged into higher level aggregates, which merges aggregates of several chunks as long as data is no longer changing quickly.

Further, if most of the data is deleted, aggregates may not be formed as the query will recompute the chunk anyway. Such structure gives an LSM-like O(log(N)) performance.

In this case, the aggregate maybe calculated on a query in a similar manner to that described above with regard to FIG. 5. Specifically, the aggregate for each run can take the previous aggregate value and remove any deleted rows in the run. For example, FIG. 6 shows one case with an addition and subtraction of “1” used for the reduce and remove functions respectively.

Thus, from FIG. 6 and the delete mask 620, the aggregates are Chunk1+Chunk2+Chunk3+Chunk4+Chunk5+Chunk6=(5+remove(chunk1 Row 3))+(5)+(5+remove(chunk3 row2))+(5)+(5)+(5+remove(chunk6 row 3).

In a further embodiment, some of the aggregates may be consolidated. Reference is now made to FIG. 7, which shows chunks 710 which have a delete mask 720. A first level aggregate 730 and a second level aggregate 740 are shown in FIG. 7. However, such level aggregates are provided only for illustration and the consolidation of the aggregates may be done in various ways.

In particular, first level aggregate table 730 consolidates chunks 1 and 2, chunks 3 and 4, and chunks 5 and 6 into separate entries. The level 2 aggregate table 740 consolidates chunks three to six into a single entry. In this case, chunks 1 to 2 are still be found in level 1 aggregate table 730.

Using the consolidated aggregate tables, a similar algorithm to that described with regard to FIG. 6 could be used. In this case, readers may scan higher level aggregates first such as those in table 740 and then base aggregates for anything not found in higher level aggregates.

The hierarchy of aggregates is not necessary in all cases. The cached aggregate can save a “K” time processing period. For example, if each chunk is 100,000 rows, the cache can be 100,000 times faster than recomputing the data.

Thus, as seen from FIGS. 6 and 7, the aggregate may be the sum of the remaining rows and the deleted rows are removed from the aggregate

### Example Hardware

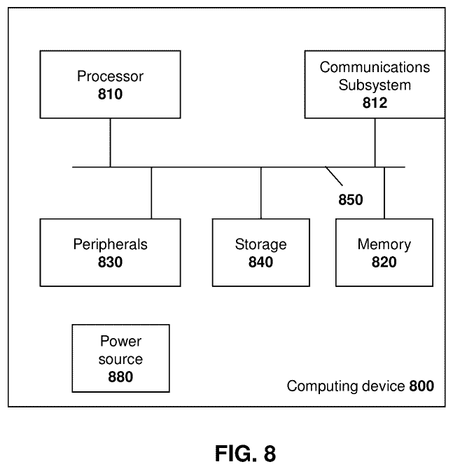

The above functionality may be implemented on any one or combination of computing devices. FIG. 8 is a block diagram of a computing device 800 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, etc. The computing device 800 may comprise a central processing unit (CPU) or processor 810, communications subsystem 812, memory 820, a mass storage device 840, and peripherals 830.

Peripherals 830 may comprise, amongst others one or more input/output devices, such as a speaker, microphone, mouse, touchscreen, keypad, keyboard, printer, display, network interfaces, and the like.

Communications between processor 810, communications subsystem 812, memory 820, mass storage device 840, and peripherals 830 may occur through one or more buses 850. The bus 850 may be one or more of any type of several bus architectures including a memory bus or memory controller, a peripheral bus, video bus, or the like.

The processor 810 may comprise any type of electronic data processor. The memory 820 may comprise any type of system memory such as static random-access memory (SRAM), dynamic random access memory (DRAM), synchronous DRAM (SDRAM), read-only memory (ROM), a combination thereof, or the like. In an embodiment, the memory 820 may include ROM for use at boot-up, and DRAM for program and data storage for use while executing programs.

The mass storage device 840 may comprise any type of storage device configured to store data, programs, and other information and to make the data, programs, and other information accessible via the bus. The mass storage device 840 may comprise, for example, one or more of a solid-state drive, hard disk drive, a magnetic disk drive, an optical disk drive, or the like.

In embodiments, a processor 810 may execute instruction code stored in a non-transitory computer readable medium such as memory 820 or mass storage device 840 to perform the methods described herein.

The computing device 800 may also include a communications subsystem 812, which may include one or more network interfaces, which may comprise wired links, such as an Ethernet cable or the like, and/or wireless links to access nodes or different networks. The communications subsystem 812 allows the processing unit to communicate with remote units via the networks. For example, the communications subsystem 812 may provide wireless communication via one or more transmitters/transmit antennas and one or more receivers/receive antennas. In an embodiment, the processing unit is coupled to a local-area network or a wide-area network, for data processing and communications with remote devices, such as other processing units, the Internet, remote storage facilities, or the like.

The embodiments described herein are intended to be illustrative of the present compositions and methods and are not intended to limit the scope of the present invention. Various modifications and changes consistent with the description as a whole and which are readily apparent to the person of skill in the art are intended to be included. The appended claims should not be limited by the specific embodiments set forth in the examples, but should be given the broadest interpretation consistent with the description as a whole.

1. A method comprising:
incrementally maintaining aggregates in a data structure for a large data system having immutable or append data structures, the maintaining comprising:
selecting a chunk of data;
determining whether an aggregate exists for the selected chunk of data;
when the aggregate exists:
determining that a number of deleted rows for the chunk of data exceeds zero; and
performing a remove function to remove any deleted rows from the aggregate; and
when the aggregate does not exist:
performing a reduce function to create the aggregate,
wherein the performing the remove function and performing the reduce function occur asynchronously in a background process, thereby reducing delay in write operations in the large data system.

2. The method of claim 1, further comprising, when the aggregate exists:
determining that a number of deleted rows in the aggregate exceeds a threshold; and
performing the reduce function to create a new aggregate.

3. The method of claim 1, wherein the data structure has a deleted rows indicator.

4. (canceled)

5. The method of claim 1, wherein the aggregate is one of: a sum; a minimum; a maximum; an average; a number of records; and a product of data within the data structure.

6. The method of claim 5, wherein the reduce and remove functions are tailored to a type of aggregate.

7. The method of claim 6, wherein, for a sum aggregate, the reduce function adds a row value to the aggregate and the remove function subtracts a row value from the aggregate.

8. The method of claim 1, wherein the data structure is a log-structured merge (LSM) storage architecture.

9. The method of claim 1, further comprising creating aggregate tables merging aggregates together.

10. The method of claim 1, further comprising updating a full aggregate with results from the reduce or remove function.

11. A computing device comprising:
a memory; and
a processor,
wherein the computing device is configured to:
incrementally maintain aggregates in a data structure for a large data system having immutable or append data structures, the computing device being configured to:
select a chunk of data;
determine whether an aggregate exists for the selected chunk of data;
when the aggregate exists:
determine that a number of deleted rows for the chunk of data exceeds zero; and
perform a remove function to remove any deleted rows from the aggregate; and
when the aggregate does not exist:
perform a reduce function to create the aggregate,
wherein the computing device is configured to perform the remove function and perform the reduce function asynchronously in a background process, thereby reducing delay in write operations in the large data system.

12. The computing device of claim 11, wherein the computing device is further configured to, when the aggregate exists:
determine that a number of deleted rows in the aggregate exceeds a threshold; and
perform the reduce function to create a new aggregate.

13. The computing device of claim 11, wherein the data structure has a deleted rows indicator.

14. The computing device of claim 11, wherein the aggregate is one of: a sum; a minimum; a maximum; an average; a number of records; and a product of data within the data structure.

15. The computing device of claim 14, wherein the reduce and remove functions are tailored to a type of aggregate.

16. The computing device of claim 15, wherein, for a sum aggregate, the reduce function adds a row value to the aggregate and the remove function subtracts a row value from the aggregate.

17. The computing device of claim 11, wherein the data structure is a log-structured merge (LSM) storage architecture.

18. The computing device of claim 11, wherein the computing device is further configured to create aggregate tables merging aggregates together.

19. The computing device of claim 11, wherein the computing device is further configured to update a full aggregate with results from the reduce or remove function.

20. A computer readable medium for storing instruction code, which, when executed by a computing device cause the computing device to:
incrementally maintain aggregates in a data structure for a large data system having immutable or append data structures, the instruction code causing the computing device to:
select a chunk of data;
determine whether an aggregate exists for the selected chunk of data;
when the aggregate exists:
determine that a number of deleted rows for the chunk of data exceeds zero; and
perform a remove function to remove any deleted rows from the aggregate; and
when the aggregate does not exist:
perform a reduce function to create the aggregate,
wherein the instruction code causes the computing device to perform the remove function and perform the reduce function asynchronously in a background process, thereby reducing delay in write operations in the large data system.
